(19) United States
(12) Patent Application Publication
(10) Pub. No.: US 2019/0122249 A1
(43) Pub. Date: Apr. 25, 2019

(54) RESOURCE ALLOCATION METHOD AND RELATED DEVICE AND DISPLAY METHOD AND RELATED DEVICE

(71) Applicant: ALIBABA GROUP HOLDING LIMITED, Grand Cayman (KY)

(72) Inventors: TAO ZHU, HANGZHOU (CN); LAN LI, HANGZHOU (CN); YING ZHU, HANGZHOU (CN); ZONGYI XIE, HANGZHOU (CN); BING WANG, HANGZHOU (CN); JIAN SONG, HANGZHOU (CN); ZHICAN ZHENG, HANGZHOU (CN)

(21) Appl. No.: 16/167,966

(22) Filed: Oct. 23, 2018

(30) Foreign Application Priority Data
Oct. 24, 2017 (CN) 201711000955.7

(51) Int. Cl. G06Q 30/02; G06F 3/0481

(52) U.S. Cl. CPC G06Q 30/0233; G06F 3/04812; G06Q 30/0224; G06Q 30/0232

(57) ABSTRACT

A resource allocation method comprises: obtaining control data input by a user; determining a target interface area corresponding to the control data input by the user, wherein a displayed resource allocation interface comprises the target interface area; and determining a target allocation resource according to resource information associated with the target interface area.

### CROSS REFERENCE TO RELATED APPLICATIONS

The present application claims priority to Chinese Patent Application No. 201711000955.7 filed on Oct. 24, 2017 and entitled “RESOURCE ALLOCATION METHOD AND RELATED DEVICE AND DISPLAY METHOD AND RELATED DEVICE,” the entire content of which is incorporated herein by reference in the entirety.

### TECHNICAL FIELD

The present application relates to the field of software technologies, and in particular, to a resource allocation method and a related device and a display method and a related device.

### BACKGROUND

At present, to improve the interactivity with users, some programs may provide interactive games. Users may receive corresponding rewards by completing game levels. Rewards may include various forms, such as red envelope, coupon, point, lucky draw chance, data recharge card, and the like. These rewards may be deemed as resources. Users may obtain particular benefits from these resources during the use of a program.

### SUMMARY

In view of this, the current disclosure presents a resource allocation method for providing a new interaction method of allocating a corresponding resource to a user based on control data input by the user. In addition, the present disclosure further provides a display method for displaying a resource allocation result.

According to one aspect, a resource allocation method comprises: obtaining control data input by a user; determining a target interface area corresponding to the control data input by the user, wherein a displayed resource allocation interface comprises the target interface area; and determining a target allocation resource according to resource information associated with the target interface area.

In some embodiments, the resource allocation method further comprises: allocating the target allocation resource to the user. The resource may comprise data packets.

In some embodiments, the control data comprises any one of the following items: audio value, exhaling value, shaking frequency, frequency of clicking a resource allocation interface, and eye blink frequency.

In some embodiments, the determining a target interface area corresponding to the control data input by the user comprises: determining an interface length corresponding to the control data input by the user; and determining an interface location corresponding to the control data according to a preset reference location and the interface length, and determining an interface area in which the interface location is located as the target interface area.

In some embodiments, the control data comprises a plurality of pieces of control data obtained for a plurality of times within a continuous period of time; and the determining an interface length corresponding to the control data input by the user comprises: determining an interface length corresponding to the each piece of control data obtained for the each time according to a relationship among interface length, control data, and number of obtaining times.

In some embodiments, the determining an interface length corresponding to the control data input by the user comprises: determining the interface length corresponding to the control data input by the user according to a directly proportional correspondence between the control data and the interface length.

In some embodiments, the determining a target allocation resource according to resource information associated with the target interface area comprises: determining a target interface area corresponding to control data obtained last time; and determining resource information associated with the target interface area as the target allocation resource.

In some embodiments, the determining a target allocation resource according to resource information associated with the target interface area comprises: obtaining a plurality of pieces of resource information associated with each of a plurality of target interface areas respectively; and determining a largest piece of the plurality of pieces of resource information or a sum value of the plurality of pieces of resource information as the target allocation resource.

In some embodiments, the method further comprises: obtaining historical control data of the user; and comparing the historical control data with the control data, and outputting indication information corresponding to the comparison result.

In some embodiments, the method further comprises: obtaining control data of another user; and comparing the control data of the user with the control data of the another user, and outputting indication information corresponding to the comparison's result.

In some embodiments, the resource allocation interface comprises a controlled object, and the method further comprises: moving the controlled object to an interface location corresponding to the target interface area.

In some embodiments, the resource allocation interface comprises a controlled object, and the indicating the target interface area comprises: changing a form of the target interface area to a target form corresponding to the target interface area.

In some embodiments, the method further comprises: recording one or more of the target allocation resources allocated within a preset time length to the user; and if a number of same target allocation resources of the one or more of the target allocation resources reaches a preset value, outputting indication information and stopping the allocation of the same target allocation resources to the user.

In some embodiments, the method further comprises: displaying a background picture having an extension effect, wherein a speed of the extension is directly proportional to a change degree of the control data.

In some embodiments, the method further comprises: sending an access portal of the resource allocation interface to a sharing platform based on a sharing operation.

According to another aspect, a resource allocation device comprises a processor and a non-transitory computer-readable storage medium storing instructions that, when executed by the processor, cause the resource allocation device to perform a method. The method comprises: obtaining control data input by a user; determining a target interface area corresponding to the control data input by the user, wherein a displayed resource allocation interface comprises the target interface area; and determining a target allocation resource according to resource information associated with the target interface area.

According to another aspect, a resource allocation device comprises: a display configured to display a resource allocation interface; an input device configured to collect control data input by a user; and a processor configured to: determine a target interface area corresponding to the control data input by the user, wherein the resource allocation interface comprises the target interface area, determine a target allocation resource according to resource information associated with the target interface area, and allocate the target allocation resource to the user.

According to another aspect, the present disclosure provides a resource allocation method, including: displaying a resource allocation interface, where the resource allocation interface includes at least one interface area, and the interface area is associated with resource information and corresponds to control data; collecting control data input by a user, and determining a target interface area corresponding to the control data input by the user; determining a target allocation resource according to resource information associated with the target interface area; and allocating the target allocation resource to the user.

According to a second aspect, the present disclosure provides a display method, including: displaying a resource allocation interface, where the resource allocation interface includes at least one interface area, and the interface area is associated with resource information and corresponds to control data; collecting control data input by a user, and determining a target interface area corresponding to the control data input by the user; determining a target allocation resource according to resource information associated with the target interface area; and displaying the target allocation resource on the resource allocation interface.

According to another aspect, the present disclosure provides a resource allocation apparatus, including: a unit for displaying a resource allocation interface, configured to display a resource allocation interface, where the resource allocation interface includes at least one interface area, and the interface area is associated with resource information and corresponds to control data; a unit for determining a target interface area, configured to: collect control data input by a user, and determine a target interface area corresponding to the control data input by the user; a unit for determining a target allocation resource, configured to determine a target allocation resource according to resource information associated with the target interface area; and a unit for allocating a target allocation resource, configured to allocate the target allocation resource to the user.

According to another aspect, the present disclosure provides a resource allocation device, including: a display, configured to display a resource allocation interface, where the resource allocation interface includes at least one interface area, and the interface area is associated with resource information and corresponds to control data; an input device, configured to collect control data input by a user; and a processor, configured to: determine a target interface area corresponding to the control data input by the user; determine a target allocation resource according to resource information associated with the target interface area; and allocate the target allocation resource to the user.

According to another aspect, the present disclosure provides a display apparatus, including: a unit for displaying a resource allocation interface, configured to display a resource allocation interface, where the resource allocation interface includes at least one interface area, and the interface area is associated with resource information and corresponds to control data; a unit for determining a target interface area, configured to: collect control data input by a user, and determine a target interface area corresponding to the control data input by the user; a unit for determining a target allocation resource, configured to determine a target allocation resource according to resource information associated with the target interface area; and a unit for displaying a target allocation resource, configured to display the target allocation resource on the resource allocation interface.

According to another aspect, the present disclosure provides a display device, including: a display, configured to: display a resource allocation interface, where the resource allocation interface includes at least one interface area, and the interface area is associated with resource information and corresponds to control data; and display a target allocation resource on the resource allocation interface; an input device, configured to collect control data input by a user; and a processor, configured to: determine a target interface area corresponding to the control data input by the user; and determine a target allocation resource according to resource information associated with the target interface area.

The disclosed resource allocation method may provide a resource allocation interface including an interface area. The interface area corresponds to control data and is associated with resource information. Therefore, after control data input by a user is collected, the interface area corresponding to the control data may be determined, an allocation resource to be allocated to the user is determined according to resource information associated with the control data, and the allocation resource is allocated to the user. Thus, the present disclosure achieves the objective of allocating a resource based on control data input by a user and embodies a user interaction process.

### BRIEF DESCRIPTION OF THE DRAWINGS

To describe the technical solutions of the embodiments of the present disclosure or the existing technology more clearly, the following briefly introduces the accompanying drawings required for describing the embodiments or the existing technology. Apparently, the accompanying drawings in the following description show only some embodiments of the present disclosure, and a person of ordinary skill in the art may still derive other drawings from these provided accompanying drawings without creative efforts.

FIG. 1 is a schematic diagram of an application scenario of a resource allocation method according to various embodiments of the present disclosure.

FIG. 2 is a flowchart of a resource allocation method according to various embodiments of the present disclosure.

FIG. 3 is a schematic diagram of a resource allocation interface according to various embodiments of the present disclosure.

FIG. 4A to FIG. 4D are schematic diagrams of an application process of a resource allocation method according to various embodiments of the present disclosure.

FIG. 5 is a schematic structural diagram of a resource allocation apparatus according to various embodiments of the present disclosure.

FIG. 6 is a schematic structural diagram of a resource allocation device according to various embodiments of the present disclosure.

FIG. 7 is a schematic structural diagram of a display apparatus according to various embodiments of the present disclosure.

FIG. 8 is a schematic structural diagram of a display device according to various embodiments of the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are some, rather than all, of the embodiments of the present disclosure. All other embodiments obtainable by a person of ordinary skill in the art based on the embodiments of the present disclosure without creative efforts shall fall within the protection scope of the present disclosure.

Some websites provide users with interactive applets to improve the interactivity with users. Users may receive rewards during interaction. The rewards are resources, which may include, but are not limited to, red envelope, coupon, point, lucky draw chance, data recharge card, and the like.

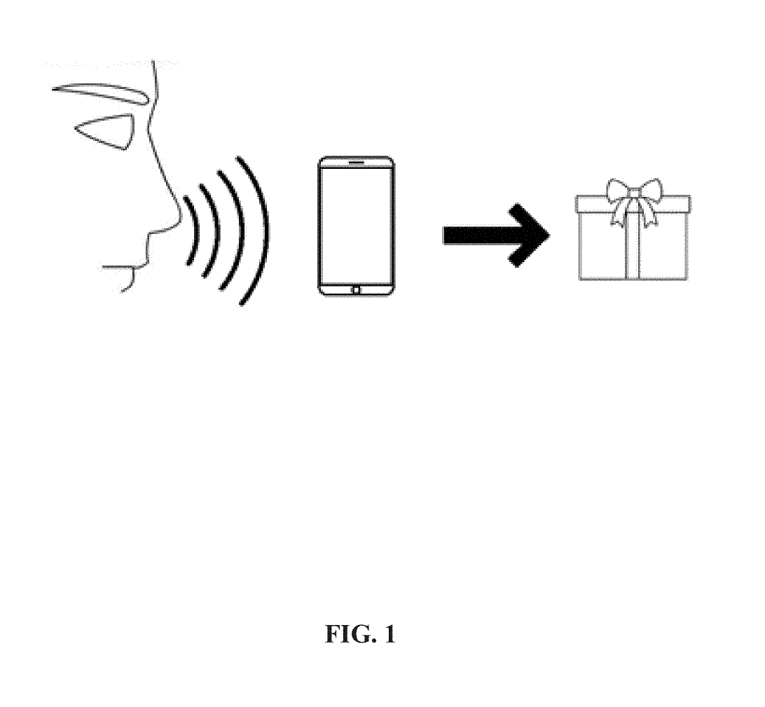

The present disclosure provides a resource allocation method. The method may be applied to a client such as a mobile phone. As shown in FIG. 1, a user may input control data such as audio to a client. The client allocates a corresponding resource such as a red envelope to the user according to a magnitude of the control data input by the user. A gift box in FIG. 1 represents a resource.

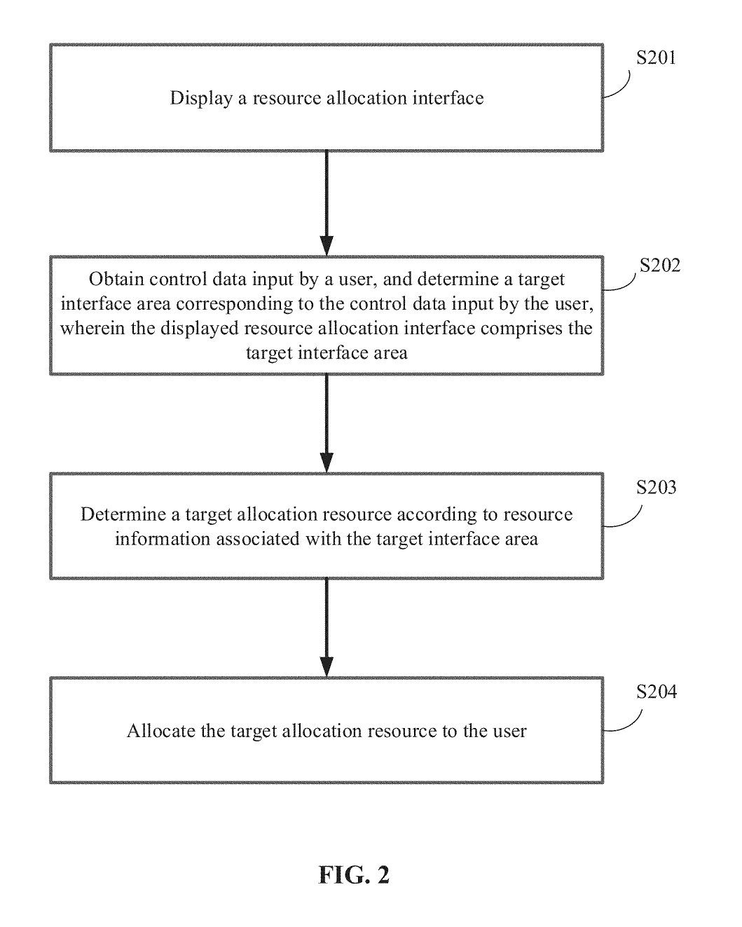

Referring to FIG. 2, FIG. 2 shows a detailed procedure of a resource allocation method. The procedure includes the following steps S201 to S204.

S201: Display a resource allocation interface. In various embodiments, the resource allocation interface includes at least one interface area, the interface area has a correspondence with control data, and the interface area is associated with resource information. S201 may be optional.

In some embodiments, during actual application, an access portal may be provided to users. For example, a floating icon is used to represent a game portal on a homepage of a website. A user may enter a game page by clicking the floating icon. After the user enters the game page, a client may display a resource allocation interface. The interface includes one or more areas.

A correspondence between an interface area and control data input by the user is set in advance. The user inputs control data with a magnitude, and an interface area corresponding to the control data may be determined according to the correspondence. The control data may refer to a magnitude of the control data. The interface area occupies a particular location range on the resource allocation interface. Therefore, the correspondence between control data and an interface area may refer to a correspondence between a magnitude of a control data and a location range of an interface area. Control data within a range of magnitude corresponds to an interface area having a location range. Control data with another magnitude range corresponds to an interface area having another location range. Distribution relationships among a plurality of interface areas may represent the change of control data.

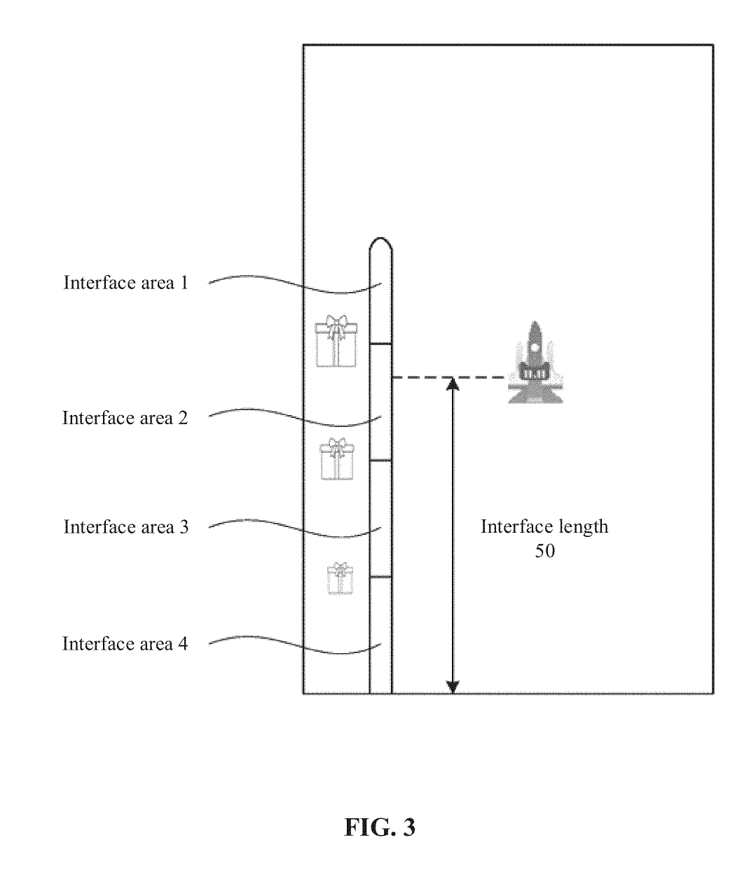

FIG. 3 illustrates an example. The resource allocation interface includes four interface areas, that is, four rectangular areas. The four interface areas are arranged in a sequentially ascending manner, to form an area with a shape similar to that of a thermometer. The control data is an audio volume input by a user. An interface area corresponding to a higher audio volume has a higher location in the resource allocation interface. This distribution relationship of interface areas can intuitively reflect the change of the audio volume. FIG. 3 is only an example for description. The interface area may further be in another form such as a dot or a line.

In addition, different interface areas are associated with different resource information. The resource information is used to represent what a resource is and an amount of the resource. When control data of a user can reach an interface area, the user may obtain the resource represented by the resource information associated with the interface area.

Moreover, a resource icon related to resource information may be displayed at a location corresponding to an interface area to show the user a general condition of the resource information associated with the interface area. It may be understood that a resource icon and a resource grade have a correspondence. When a resource grade is higher, the resource icon correspondingly represents a higher resource grade. For example, a resource is a red envelope. When a red envelope associated with an interface area has a larger amount, a displayed red envelope icon is larger. Further, as shown in FIG. 3, a resource is a red envelope, and a resource icon is a gift box. When a red envelope corresponding to an interface area has a larger amount, a displayed gift box is larger. The resource icon may further have another presentation form, and is not limited to the foregoing example.

S202: Obtain control data input by the user, and determine a target interface area corresponding to the control data input by the user, wherein the resource allocation interface comprises the target interface area. For example, an input device (e.g., microphone, gyroscope, gas sensor, touch sensor, gravity sensor, or another sensing device described in this disclosure) may collect the control data, and a processor may obtain the control data from the input device. For the simplicity of description, “collect” or “collection” described in this disclosure may refer to the input device and/or the processor obtaining the control data.

In some embodiments, a client may continuously collect control data input by a user within a period of time, and at least one piece of control data is collected. The period of time may be a preset value, for example, 10 seconds. To make it convenient for a user to learn about a time progress, a countdown may be displayed at a corner location on the resource allocation interface. The length of a period of time may alternatively not be preset on the client. Instead, trigger operations of the user may determine a start time and an end time. For example, a start button and an end button are provided. Collection starts based on an operation of clicking the start button by the user, and ends based on an operation of clicking the end button by the user.

The control data may be biometric data, which includes, but is not limited to, audio volume, exhaling amount, frequency of shaking an electronic device, frequency of clicking a resource allocation interface, eye blink frequency, and the like. An audio collection device such as a microphone may be disposed on the client to collect the audio volume. A gas sensor may be disposed on the client to collect the exhaling amount. A gravity sensor such as an accelerometer may be disposed on the client to collect the frequency of shaking the electronic device such as a client. A touch sensor may be disposed on the client to collect the frequency of clicking the resource allocation interface. An image collection device such as a camera may be disposed on the client to collect the eye blink frequency. A corresponding hardware unit may be disposed on the client according to the type of control data that needs to be collected.

As discussed above, the correspondence between an interface area and control data is set in advance. Therefore, after control data input by a user is collected, the correspondence may be used to search for a corresponding interface area, and a found interface area is referred to as a target interface area.

An interface area has a one-to-multiple correspondence with control data. That is, a plurality of pieces of control data may correspond to one same interface area. In other words, one interface area corresponds to a value range of control data. Control data that falls within the value range may correspond to the same interface area.

In one example, a method for determining a target interface area corresponding to the control data may include: determining an interface length corresponding to the control data; and determining an interface location corresponding to the control data according to a preset reference location and the interface length, and determining an interface area in which the interface location is located as the target interface area.

After a user inputs control data, a client first determines an interface length corresponding to the control data. The interface length is a length from a preset reference location as a starting point on an interface. The interface length may represent a magnitude of the control data. Next, the interface length and the preset reference location are summed to determine a location corresponding to the control data on the interface, and an interface area corresponding to the interface location is determined as the target interface area.

For example, the control data of the user is an audio volume of 50 decibels. According to a conversion relationship, the audio volume of 50 decibels may be converted into a length on the interface. Assuming that the audio volume of 50 decibels is converted into an interface length of 50 millimeters, and using FIG. 3 as an example, the preset reference location is the bottom of the resource allocation interface. It may be known that the interface length is 50 millimeters. Assuming that an interface location corresponding to the interface length of 50 millimeters is a dotted-line location, according to the interface location, it may be determined that an interface area corresponding to the interface location is an interface area 2.

Furthermore, to make it convenient for the user to intuitively view the input control data, the target interface area may be indicated. An indication manner may be changing a presentation form of the target interface area. For example, a color fills the target interface area. Different interface areas have different indication manners. As shown in FIG. 3, as an example, a corresponding filling color preset for an interface area 1 is yellow, a corresponding filling color preset for an interface area 2 is green, and a corresponding filling color preset for an interface area 3 is red. Alternatively, a filling color for an interface area may be another form such as a color gradient. An interface area may be in the form of a dot or a line. If an interface area is a dot, during the indication of the target interface area, the color of the dot can be changed. This is similarly applicable to an interface area in a line form.

Alternatively, the manner of indicating the target interface area may be moving a controlled object included in the resource allocation interface to an interface location corresponding to the target interface area. The interface location corresponding to the target interface area may be a location represented by an interface length calculated according to the control data. Using FIG. 3 as an example, the resource allocation interface includes a controlled object in the form of a plane. After collecting audio volume input by a user, a client may calculate an interface length corresponding to a magnitude of the audio volume, so as to move the controlled object in the plane form to a location corresponding to the interface length to present an effect that the audio volume input by the user makes the plane fly. Moreover, a sensor may further be used to detect the sway of the client, and correspondingly change a movement distance of the controlled object such as the plane in a direction perpendicular to the advancing direction of the plane.

Alternatively, the manner of indicating the target interface area may include the foregoing two methods.

S203: Determine a target allocation resource according to resource information associated with the target interface area. The resource may comprise, for example, data packets.

In some embodiments, the resource associated with the interface area is preset. Resource information associated with the target interface area may be determined according to this association relationship. Because a plurality of pieces of control data may be collected, a plurality of target interface areas may be determined. In this case, a resource that is eventually allocated to the user needs to be determined according to resource information associated with at least one target interface area in this step. To facilitate description, the eventually determined resource may be referred to as a target allocation resource.

If there is one target interface area, a resource associated with the target interface area may be directly determined as the target allocation resource. If a plurality of target interface areas are provided and are determined according to control data that is continuously collected at different times within a period of time, it indicates that the control data input by the user has different magnitudes. However, different allocation manners may be used to determine a target allocation resource. For example, a resource associated with an interface area corresponding to the largest control data may be determined as the target allocation resource. For another example, a sum of resources associated with interface areas corresponding to all of the control data may be determined as the target allocation resource. For still another example, a resource associated with an interface area corresponding to control data that is input last may be determined as the target allocation resource.

S204: Allocate the target allocation resource to the user.

S204 may optional. Alternatively, S204 may comprise displaying the target allocation resource on the resource allocation interface.

In some embodiments, in a resource allocation method, an allocation request may be sent to a server. The allocation request is used for requesting to add information of a target allocation resource to information of an account of a user. For example, the target allocation resource is in the form of a red envelope. In this case, a red envelope amount corresponding to the target allocation resource is added to the information item “My Red Envelope” in an account of the user. The target allocation resource may be taken from a preset total resource value and allocated to the user. Alternatively, the user may further send a request requesting the target allocation resource from a resource of another user, and after the another user accepts the request, the target allocation resource may be taken from the resource of the another user and allocated to the user.

As can be known from the foregoing technical solutions, the present disclosure provides a resource allocation method. In the resource allocation method, a resource allocation interface may be displayed. The interface includes at least one interface area. Control data input by a user is collected, and an interface area corresponding to the control data is determined. If the collected control data is different, indicated interface areas may be different. The change of an interface area may represent the change of control data, so that the user can intuitively see the change of the input control data. An interface area is associated with resource information. After the interface area corresponding to the control data is determined, a target allocation resource is determined according to the resource information associated with the interface area, and the target allocation resource is allocated to the user. Thus, this method may implement an interaction process of allocating a resource based on control data.

The present disclosure further provides a display method for displaying a determined target allocation resource to a user. The first three steps in the display method are the same as those in the foregoing resource allocation method. A difference is that the fourth step is replaced with displaying of a target allocation resource of a resource allocation interface. For example, indication information including the target allocation resource is generated and displayed to remind the user of a resource that the user obtains. For example, the target allocation resource is a red envelope of 20 Yuan (RMB), and indication information “You've got a red envelope of 20 Yuan. Congratulations!” is generated and displayed.

How to determine, according to control data input by a user, a resource to be allocated to the user is described below in detail in terms of technical implementation.

As discussed above, after control data is collected, a corresponding interface length needs to be determined according to the control data, and a target interface area may then be determined according to the interface length and a reference location.

In some embodiments, how to determine an interface length corresponding to control data is described. If the control data is collected for a plurality of times within a period of time, in an implementation, a number of collection times of each piece of control data (at which being collected) may be determined, and an interface length corresponding to the control data collected each time is calculated according to a relationship among an interface length, control data, and a number of collection times.

For example, the relationship among an interface length, control data, and a number of collection times is: h=V0+Vt*T−V0*T, where h is an interface length, V0 is a preset interference value of control data, Vt is collected control data, and T is a number of collection times within a period of time.

Using audio volume collection as an example, V0 is a decibel value of an environment. For example, if an earpiece is plugged into the client, a preset value of V0 is 5 decibels. If no earpiece is plugged into a client, a preset value of V0 is 40 decibels. Other values may also be used, and are not specifically limited in the present disclosure. In some embodiments, it is assumed that collection duration is 10 seconds, and the audio volume input by a user is collected once every second. It is also assumed that the value of V0 is 40, and the audio volume input by the user collected at the first second is 70 decibels. As can be known according to the foregoing calculation formula, an interface length corresponding to the audio volume collected at the first second is: h=40+70*1−40*1=70. If the audio volume input by the user collected at the second second is 70 decibels. As can be known according to the calculation formula, an interface length corresponding to the audio volume collected at the second second is: h=40+70*2−40*2=100. If the audio volume input by the user collected at the tenth second is 50 decibels. As can be known according to the calculation formula, an interface length corresponding to the audio volume collected at the tenth second is: h=40+70*10−40*10=340. Similarly, an interface length corresponding to control data collected at another time may be calculated.

The value of V0 of collected control data is generally greater than the preset interference value Vt of control data. Therefore, as can be known according to the foregoing calculation formula, if control data input by a user remains unchanged, when a number of collection times is larger, a corresponding interface length is larger. The reason is that as time passes by, it becomes relatively difficult for the user to keep inputting the same control data. Therefore, an interface length corresponding to control data in a later period may be larger than that in an early period. The calculation formula used in the foregoing implementation may achieve such an effect.

The present disclosure further provides another method to determine an interface length corresponding to control data. That is, the interface length corresponding to the control data is determined according to a directly proportional correspondence between control data and an interface length. For example, a correspondence between control data and an interface length may be preset. The correspondence is a directly proportional relationship. That is, when the control data is larger, the corresponding interface length is larger, and the degree by which control data increases is the same as the degree by which an interface length increases.

For example, the control data is audio volume, and it is assumed that a proportion value of control data to an interface length is 2. Therefore, if control data is 50 decibels, a corresponding interface length is 100. If control data is 60 decibels, a corresponding interface length is 120. The proportion value of control data to an interface length is not limited to 2, and may further be another value. In addition, the proportion value may be set to different values according to forms of control data.

After an interface length is calculated according to the foregoing method, a target interface area corresponding to each piece of control data may be determined, so that resource information associated with the target interface area may further be obtained. If a plurality of target interface areas are provided, any one of the following methods may be used to determine a target allocation resource.

First method: A target interface area corresponding to the control data collected last time may be determined, and resource information associated with the target interface area is determined as the target allocation resource. For example, control data is continuously collected within a period of time. During resource allocation, an interface area corresponding to control data collected at a last time point is determined, and the resource information associated with the interface area is determined as a resource to be allocated to a user.

Second method: Resource information associated with each target interface area may be obtained respectively, and the largest resource information of a plurality of pieces of resource information is determined as the target allocation resource. In this method, the largest resource obtained by a user by using control data within a period of time is allocated to the user.

Third method: Resource information associated with each target interface area may be obtained respectively, and a sum of a plurality of pieces of resource information is determined as the target allocation resource. In this method, all resources obtained by a user by using control data within a period of time are allocated to the user.

Three methods of determining a target allocation resource are introduced in the foregoing. Any method may be used to perform allocation during actual application.

To improve interactivity, control data of a user may be compared with other control data, and indication information is provided according to the comparison result.

For example, the control data of the user in a current round may be compared with historical control data of the user. For example, in the foregoing procedure shown in FIG. 2, the historical control data of the user, for example, the last control data in a previous round, or the largest control data in previous rounds, may be obtained. Control data at a time in a current round is compared with the historical control data, and indication information is input according to the comparison result. The control data used for comparison may be control data corresponding to a preset sequence value. For example, it is preset to collect control data 10 times, and the control data at a seventh time is compared with the historical control data.

In some embodiments, it is assumed that the control data obtained at the seventh time in the current round is 50, and the obtained historical control data is 70. The control data in the current round is less than the historical control data. In this case, speech information “Try a little harder and reach higher!” may be output. In some embodiments, it is assumed that the control data obtained at the seventh time in the current round is 60, and the obtained historical control data is 50. The control data in the current round is greater than the historical control data. In this case, speech information “Congratulations, you surpassed your previous performance!” may be output. The form of the indication information is not limited to speech, and the indication information may further be in various forms such as text and dynamic effect. The dynamic effect may be, for example, fireworks, applause, etc.

For another example, the control data of the user may be compared with the control data of another user. For example, in the procedure shown in the foregoing FIG. 2, control data of another user may be obtained. The control data of the user is compared with the control data of the another user, and indication information corresponding to the comparison result is output. A client may be connected to a server. The server may collect control data on all clients that are connected to the server and have opened a resource allocation interface. For a client, the server may compare the control data of the client at a time with the control data of another client at the same time point, and sends the comparison result to the client. The comparison method may be calculating an excessive amount of data controlled by the client as to the data controlled by other clients, and an excess value such as a proportion value is sent to the client. The client outputs indication information generated by using the proportion value. Similarly, the control data used by the client in comparison may be collected at a time with a preset sequence value.

For example, it is preset to collect control data 10 times. The control data at the seventh time is compared with the historical control data. It is assumed that the control data collected at the seventh time is 50, and at the same time point, the server calculates that 40% of clients have less than the control data. The server sends the value to the client. The client may output speech information “Keep trying. You've beaten 40% of the users”. The form of the indication information is not limited to speech, and the indication information may further be in various forms such as text and dynamic effect. The dynamic effect may be, for example, fireworks and applause.

During actual application, resources obtained by a user may further be limited. For example, a target allocation resource allocated within a preset time length to the user is recorded. If a number of the same target allocation resources reaches a preset value, indication information is output and allocation of the same target allocation resource to the user is stopped.

For example, if a number of the same resources obtained by the user within 1 day needs to be limited, the preset time length is set to 1 day. For example, the preset time length is 1 day, and the preset value is 5. It indicates that a number of the same resources obtained by the user within 1 day cannot exceed 5.

To provide a user with the optimal presentation effect, a background picture of the resource allocation interface may be a background picture having an extension effect, and the speed of the extension is directly proportional to a change degree of the collected control data. If the resource allocation interface includes a controlled object, the form of the background picture may correspond to the forms of a controlled object and an interface area.

For example, the controlled object is a plane. The form of the background picture may be a sky with clouds. The form of the clouds in the sky may change. For example, the clouds may change from thick to thin, or vice versa, so as to generate a dynamic effect that the sky extends infinitely.

For another example, the controlled object is a human, and the interface area is a running track. A scene effect of the resource allocation interface is that the human completes a level to obtain a resource corresponding to the level. The form of the background picture may be trees moving in a direction opposite to that of the human, so as to generate a dynamic effect that the human keeps moving forward.

To expand an application range of the resource allocation method, a sharing function may be included. That is, options of sharing to platforms may be provided to users. An access portal of the resource allocation interface is sent to a sharing platform based on a sharing operation and/or the sharing platform that are input by the user. For example, if a user triggers a sharing operation after completing input of control data in a current round, a sharing interface is generated. The sharing interface includes options of platforms such as Moments, WeChat Friends, and Weibo. The access portal of the resource allocation interface is sent to the sharing platform according to a sharing platform selected by the user, so as to increase a possibility that the resource allocation method is performed by another user and further improve the applicability of this resource allocation method.

To improve interactivity between users, control data of different users may be compared, and a resource is allocated to a user with largest control data. In an implementation, largest control data of two users collected within the same period of time may be compared. For example, a server continuously collects audio volumes input by two users on respective clients within 10 seconds starting from a time point, and compares the largest audio volumes. In another implementation, control data of two users collected last time within the same period of time may be compared. For example, a server continuously collects audio volumes input by two users on respective clients within 10 seconds starting from a time point, and compares the audio volumes collected last time. Regardless of the method used, a resource obtained according to the control data of a winner is allocated to the winner.

To help understand the technical solutions of the resource allocation method, an implementation process is described below with reference to a detailed application scenario.

For example, the website Tmall™ holds a sales promotion activity “Double 11” on November 11. To increase the level of participation of users, an access portal for an activity “Shout out code word to win red envelopes” may be provided on the homepage of the website Tmall™. An activity introduction page may be provided after a user clicks the access portal.

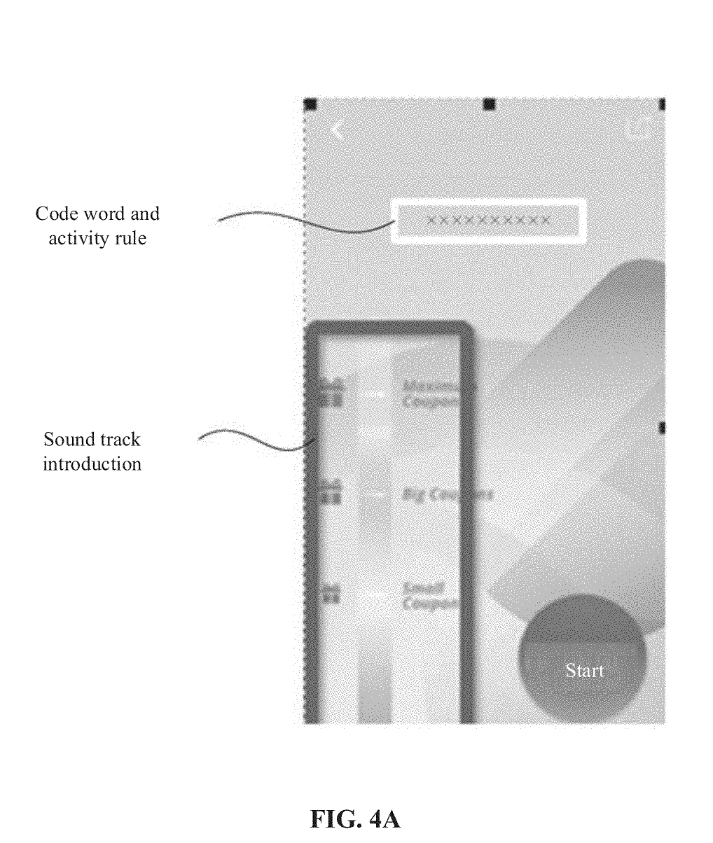

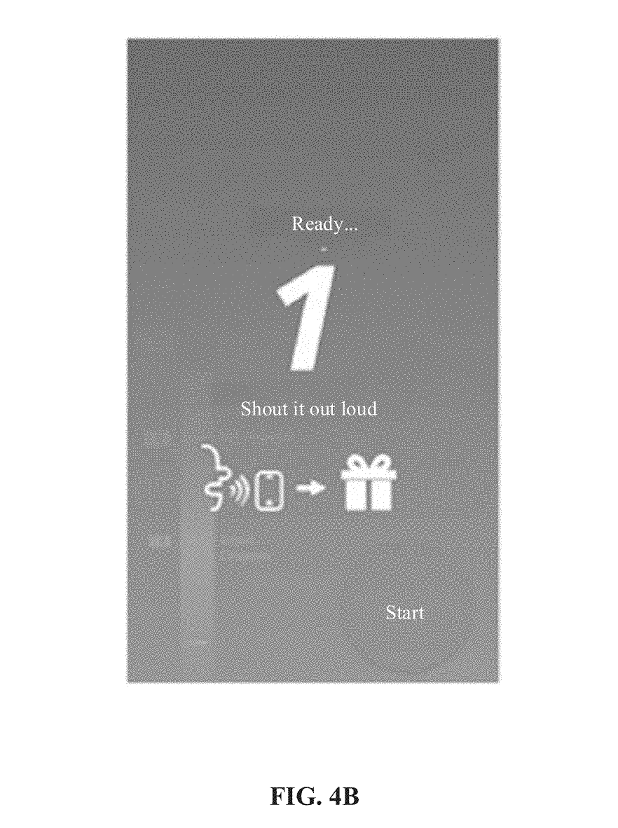

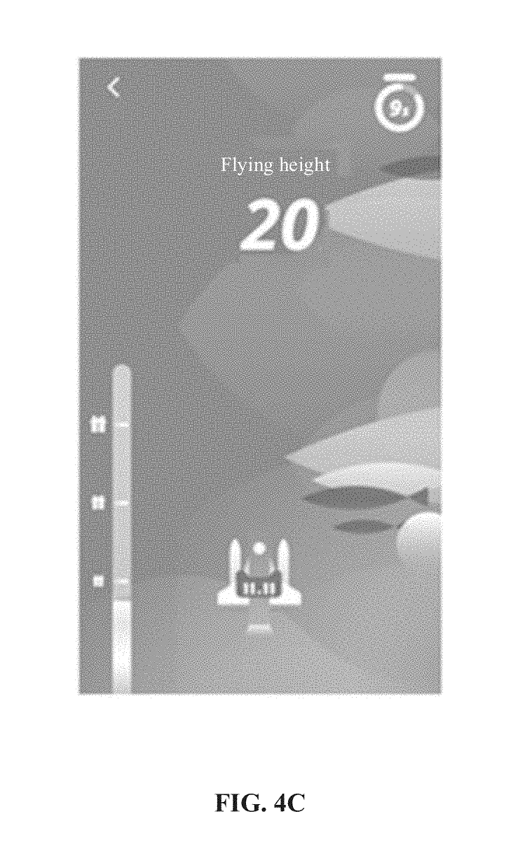

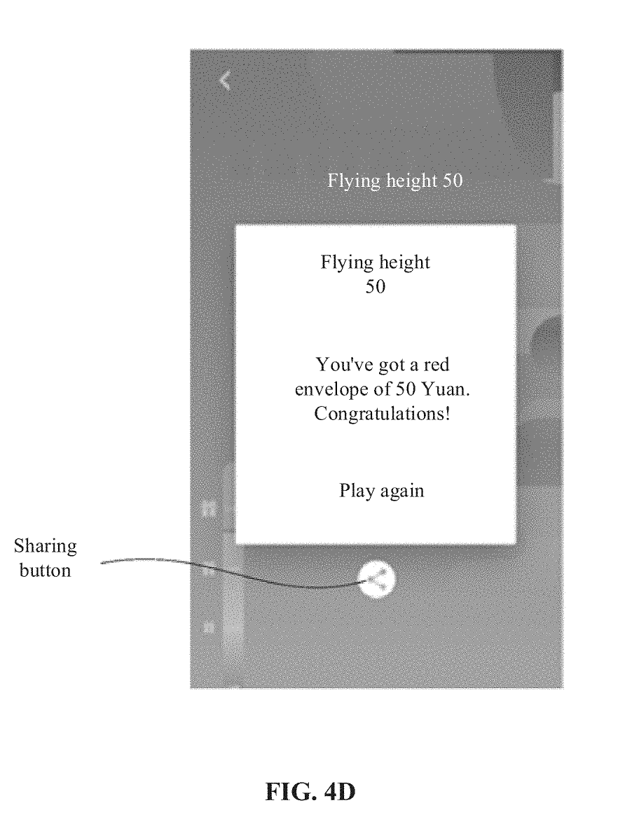

As shown in FIG. 4A, the activity introduction page may include code words such as “shop”, “buy” or “spend”, and further include an interaction rule such as “Higher decibels make the cat-head plane fly further, and lower decibels slow or even bring down the cat-head plane. Get a corresponding red envelope reward according to a category of a final fly distance of the cat-head plane”. The activity introduction page may further include the introduction of sound tracks. The sound tracks include four sections that have different colors and correspond to reward indications in the shape of gift boxes. Gift boxes sequentially become larger from the bottom to the top, indicating that reward amounts sequentially increase. In addition, the activity introduction page may further include a start button.

After a user clicks the start button, a countdown interface shown in FIG. 4B may be provided for the user to get ready. A countdown of 3 seconds may be used. 3, 2, and 1 are sequentially displayed. An indication phrase “Shout it out loud!” may further be included on the countdown interface.

After the countdown ends, the user may enter a resource sharing interface shown in FIG. 4C. The interface includes a cat-head plane, and the background picture is a sky with clouds. The user shouts out a code word at the mobile phone. The mobile phone starts timing, and a decibel value of the shouting voice of the user is collected once every second. A flying height of the cat-head plane is calculated according to the decibel value, and the cat-head plane is moved to the flying height. A section of the sound track corresponding to the flying height displays a corresponding color (a light color fills in the first section of the sound tracks represents a corresponding color). In addition, a flying height corresponding to a decibel value may be displayed on the interface in real time. A flying height corresponding to a decibel value shown in FIG. 4C is 20. During the game, if the decibels of the shouting voice of the user rise, the flying height of the cat-head plane increases. If the decibels of the shouting voice of the user remain unchanged, the flying height of the cat-head plane remains unchanged or increases slowly. If the decibels of the shouting voice of the user drop radically, the flying height of the cat-head plane decreases. During the flight of the cat-head plane, the background picture may present an extension effect. For example, clouds gradually become thinner. During the entire game, a countdown reminder may be provided at the upper right corner.

After the game ends, the largest decibel value reached by the user during the current game is determined, and a red envelope amount corresponding to a track section corresponding to the largest decibel value is displayed to the user. As shown in FIG. 4D, “Flying Height: 50. You've got a red envelope of 50 Yuan. Congratulations!” is displayed on a display interface. The display interface may further include a “Play Again” button for redirecting to the homepage of the game. In addition, the display interface may further include a sharing button. After clicking the sharing button, the user may select a sharing platform to share an access portal of the game to the selected platform.

In another implementation, the controlled object may be replaced with an object of a human figure, and the interface area may be changed from a runway to a running track. Different areas have running tracks with different colors. All other contents related to the flying height are replaced with contents related to a movement distance. On a resource sharing interface, if the decibels of the shouting voice of the user rise, a distance by which the human figure moves forward increases. If the decibels of the shouting voice of the user remain unchanged, the distance by which the human figure moves forward remains unchanged or increases slowly. If the decibels of the shouting voice of the user drop radically, the distance by which the human figure moves forward decreases. As the human figure moves forward, the background picture may present an extension effect. For example, trees move in a direction opposite to the direction in which the human figure moves. During the game, the human figure completes a level to obtain a red envelope amount corresponding to the level.

In still another implementation, the controlled object may be replaced with a coating of a scratch ticket. The interface area may be changed from a runway to a red envelope amount of the scratch ticket. Different areas have different red envelope amounts. All the remaining contents related to the flying height are replaced with contents related to a degree at which the coating is scratched away. On a resource sharing interface, if the decibels of the shout of the user rise, the scratched coating area becomes larger. If the decibels of the shout of the user remain unchanged, the scratched coating area remains unchanged or becomes larger slowly. If the decibels of the shout of the user drop radically, the scratched coating area becomes smaller. When one area's coating is entirely scratched away, the user can obtain a red envelope amount corresponding to the area.

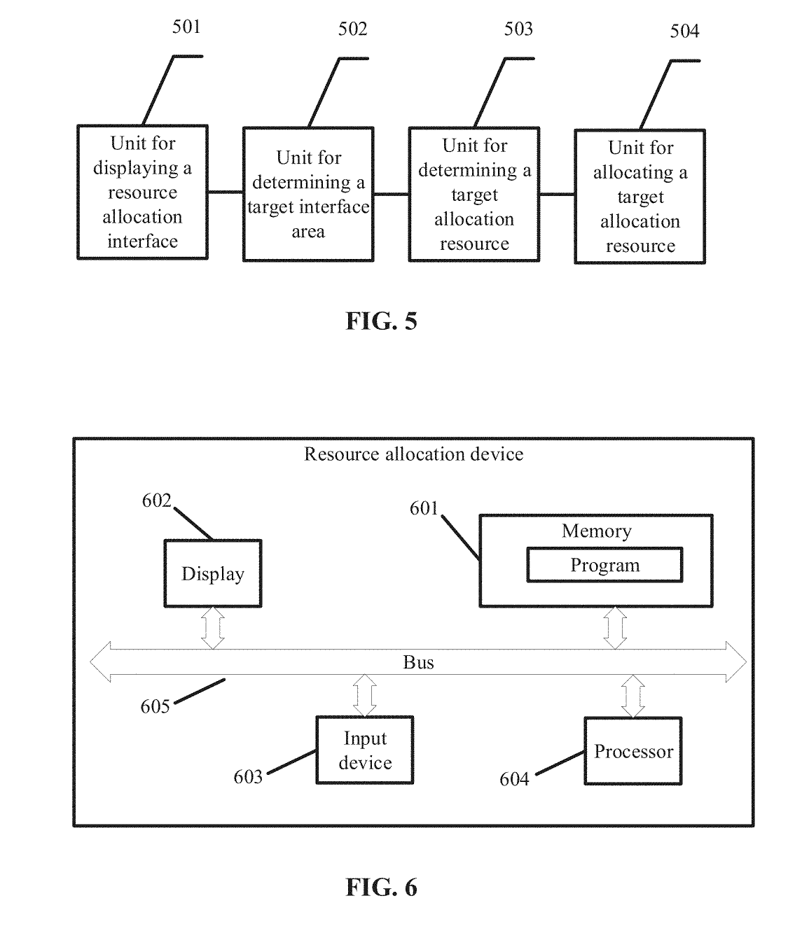

The structure of a resource allocation apparatus provided in the present disclosure is introduced below. Referring to FIG. 5, FIG. 5 is a schematic structural diagram of the resource allocation device/apparatus, which includes a unit 501 for displaying a resource allocation interface, a unit 502 for determining a target interface area, a unit 503 for determining a target allocation resource, and a unit 504 for allocating a target allocation resource.

The unit 501 for displaying a resource allocation interface is configured to display a resource allocation interface, where the resource allocation interface includes at least one interface area, and the interface area is associated with resource information and corresponds to control data.

The unit 502 for determining a target interface area is configured to: collect control data input by a user, and determine a target interface area corresponding to the control data input by the user.

The unit 503 for determining a target allocation resource is configured to determine a target allocation resource according to resource information associated with the target interface area.

The unit 504 for allocating a target allocation resource is configured to allocate the target allocation resource to the user.

When the foregoing units execute functions, the functions may be implemented in a corresponding manner in the foregoing resource allocation method, and details are not described herein.

The structure of a resource allocation device provided in the present disclosure is introduced below. The resource allocation device may be an electronic device such as a mobile phone and a tablet computer. The resource allocation device has hardware such as a sensor with a data collection function to collect control data input by a user.

In some embodiments, the various modules and units of the resource allocation device may be implemented as software instructions (or a combination of software and hardware). That is, the resource allocation device described with reference to FIG. 5 may comprise a processor and a non-transitory computer-readable storage medium storing instructions that, when executed by the processor, cause one or more components (e.g., the processor) of the resource allocation device to perform various steps and methods of the modules and units described above. In some embodiments, the resource allocation device may include a mobile phone, a tablet computer, a PC, a laptop computer, a server, or another computing device.

Referring to FIG. 6, FIG. 6 is a schematic structural diagram of a resource allocation device, which includes a memory 601 (e.g., ROM/RAM, magnetic disk, optical disk, or other memories), a display 602, an input device 603, a processor 604, and a bus 605.

The memory 601, the display 602, the input device 603, and the processor 604 are connected by using the bus 605.

The memory 601 is configured to store a software program and data. The memory 601 may be a non-transitory computer-readable storage medium storing instructions (e.g., program) that, when executed by the processor 604, cause one or more components (e.g., the processor) of the resource allocation device to perform various steps and methods of the modules and units described herein.

The display 602 is configured to display a resource allocation interface, where the resource allocation interface includes at least one interface area, and the interface area is associated with resource information and corresponds to control data.

The input device 603 is configured to collect control data input by a user. Input devices with different structures collect different forms of control data. The control data may be biometric data, which includes, but is not limited to, audio volume, exhaling amount, frequency of shaking an electronic device, frequency of clicking a resource allocation interface, and eye blink frequency. To collect certain control data, an input device corresponding to the certain control data may be disposed on the resource allocation device.

For example, to collect the audio volume, the input device is an audio collection device such as a microphone. To collect the exhaling amount, the input device is a gas sensor. To collect the frequency of shaking an electronic device such as a client, the input device is a gravity sensor such as an accelerometer. To collect the frequency of clicking a resource allocation interface, the input device is a touch sensor. To collect the eye blink frequency, the input device is an image collection device such as a camera.

The processor 604 runs the software program in the memory 601 to invoke the data stored in the memory 601 to at least perform the following steps: determining a target interface area corresponding to the control data input by the user; determining a target allocation resource according to resource information associated with the target interface area; and allocating the target allocation resource to the user.

For example, the resource allocation device may include a communication interface. To allocate a target allocation resource to a user, the processor may generate an allocation request and send the allocation request to a server by using the communication interface. The allocation request is used for requesting the server to add information of the target allocation resource to information of an account corresponding to the user. Alternatively, the allocation request may be sent to another user by using the server. The allocation request is used for requesting the another user to deliver the target allocation resource to the user.

In one example, the processor 604 being configured to determine a target interface area corresponding to the control data input by the user includes:

the processor 604 being configured to: determine an interface length corresponding to the control data input by the user; and determine an interface location corresponding to the control data according to a preset reference location and the interface length, and determine an interface area in which the interface location is located as the target interface area.

In one example, the processor 604 being configured to determine a target allocation resource according to resource information associated with the target interface area includes: the processor 604 being configured to: determine a target interface area corresponding to control data collected last time; and determine resource information associated with the target interface area as the target allocation resource.

In one example, the processor 604 being configured to determine a target allocation resource according to resource information associated with the target interface area includes: the processor 604 being configured to: if a plurality of target interface areas are provided, obtain resource information associated with each target interface area respectively; and determine largest resource information of a plurality of pieces of resource information or a sum value of a plurality of pieces of resource information as the target allocation resource.

In one example, the processor 604 is further configured to: obtain historical control data of the user; and compare the historical control data with the control data, and output indication information corresponding to the comparison result.

In one example, the processor 604 is further configured to: obtain control data of another user; and compare the control data of the user with the control data of the another user, and output indication information corresponding to the comparison result.

In one example, the processor 604 is further configured to indicate the target interface area.

In one example, the resource allocation interface includes a controlled object, and the processor 604 being configured to indicate the target interface area includes: the processor 604 being configured to move the controlled object to an interface location corresponding to the target interface area; and/or change a form of the target interface area to a target form corresponding to the target interface area.

The processor may further perform the steps related to data processing work in the foregoing embodiment of the resource allocation method and details are not described herein.

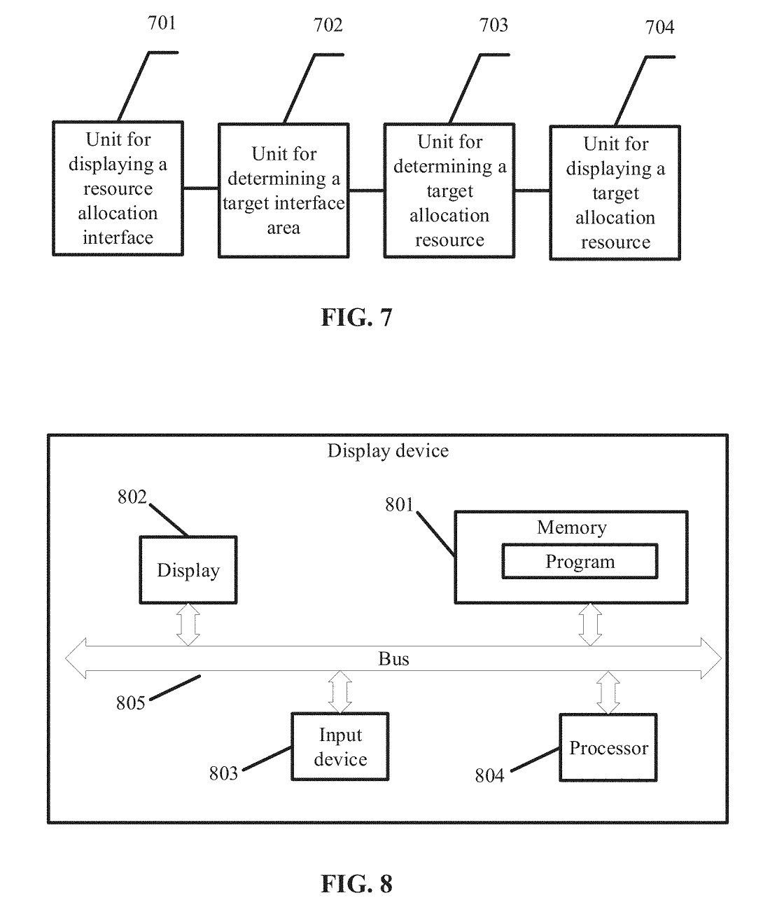

The structure of a display apparatus provided in the present disclosure is described below. Referring to FIG. 7, FIG. 7 is a schematic structural diagram of the display apparatus/device, which includes: a unit 701 for displaying a resource allocation interface, a unit 702 for determining a target interface area, a unit 703 for determining a target allocation resource, and a unit 704 for displaying a target allocation resource.

The unit 701 for displaying a resource allocation interface is configured to display a resource allocation interface, where the resource allocation interface includes at least one interface area, and the interface area is associated with resource information and corresponds to control data.

The unit 702 for determining a target interface area is configured to: collect control data input by a user, and determine a target interface area corresponding to the control data input by the user.

The unit 703 for determining a target allocation resource is configured to determine a target allocation resource according to resource information associated with the target interface area.

The unit 704 for displaying a target allocation resource is configured to display the target allocation resource on the resource allocation interface.

When the units in the display apparatus executes functions, the functions may be implemented in a corresponding manner in the foregoing resource allocation method, and details are not described herein.

The structure of a display device provided in the present disclosure is introduced below. The display device may be an electronic device such as a mobile phone and a tablet computer with a display.

In some embodiments, the various modules and units of the display device may be implemented as software instructions (or a combination of software and hardware). That is, the display device described with reference to FIG. 7 may comprise a processor and a non-transitory computer-readable storage medium storing instructions that, when executed by the processor, cause one or more components (e.g., the processor) of the display device to perform various steps and methods of the modules and units described above. In some embodiments, the display device may include a mobile phone, a tablet computer, a PC, a laptop computer, a server, or another computing device.

Referring to FIG. 8, FIG. 8 is a schematic structural diagram of a display device, which includes a memory 801 (e.g., ROM/RAM, magnetic disk, optical disk, or other memories), a display 802, an input device 803, a processor 804, and a bus 805.

The memory 801, the display 802, the input device 803, and the processor 804 are connected to by using the bus 805.

The memory 801 is configured to store a software program and data. The memory 801 may be a non-transitory computer-readable storage medium storing instructions (e.g., program) that, when executed by the processor 804, cause one or more components (e.g., the processor) of the display device to perform various steps and methods of the modules and units described herein.

The display 802 is configured to display a resource allocation interface, where the resource allocation interface includes at least one interface area, and the interface area is associated with resource information and corresponds to control data; and is configured to display the target allocation resource on the resource allocation interface.

The input device 803 is configured to collect control data input by a user. Input devices with different structures collect different forms of control data. The control data may be biometric data, which includes, but is not limited to, audio volume, exhaling amount, frequency of shaking an electronic device, frequency of clicking a resource allocation interface, and eye blink frequency. To collect certain control data, an input device corresponding to the certain control data needs to be disposed on the resource allocation device.

For example, to collect the audio volume, the input device is an audio collection device such as a microphone. To collect the exhaling amount, the input device is a gas sensor. To collect the frequency of shaking an electronic device such as a client, the input device is a gravity sensor such as an accelerometer. To collect the frequency of clicking a resource allocation interface, the input device is a touch sensor. To collect the eye blink frequency, the input device is an image collection device such as a camera.

The processor 804 runs the software program in the memory 801 to invoke the data stored in the memory 801 to at least perform the following steps: determining a target interface area corresponding to the control data input by the user; and determining a target allocation resource according to resource information associated with the target interface area. The processor 804 may send the determined target allocation resource to the display 802 for display.

The display device may further perform the steps in the foregoing resource allocation method, and details are not described herein.

The embodiments in this specification are all described in a progressive manner. Description of each of the embodiments focuses on differences from other embodiments, and reference may be made to each other for the same or similar parts among respective embodiments.

The relational terms herein such as first and second are used only to differentiate an entity or operation from another entity or operation, and do not require or imply any actual relationship or sequence between these entities or operations. Moreover, the terms “include”, “comprise”, and any variants thereof are intended to cover a non-exclusive inclusion. Therefore, in the context of a process, method, object, or device that includes a series of elements, the process, method, object, or device not only includes such elements, but also includes other elements not specified expressly, or may include inherent elements of the process, method, object, or device. Unless otherwise specified, an element limited by “include a/an . . . ” does not exclude other same elements existing in the process, the method, the article, or the device that includes the element.

The foregoing description of the disclosed embodiments enables a person skilled in the art to implement or use the present disclosure. It is apparent to a person skilled in the art to make various changes to these embodiments. The general concept defined in the specification may be implemented in other embodiments without departing from the spirit and scope of the present disclosure. Therefore, the present disclosure is not limited to these embodiments shown in the specification, and instead is to meet the widest range consistent with the principles and novel features disclosed in the specification.

What is claimed is:

1. A resource allocation method, comprising:
obtaining control data input by a user;
determining a target interface area corresponding to the control data input by the user, wherein a displayed resource allocation interface comprises the target interface area; and
determining a target allocation resource according to resource information associated with the target interface area.

2. The resource allocation method according to claim 1, further comprising: allocating the target allocation resource to the user, wherein the resource comprises data packets.

3. The resource allocation method according to claim 1, wherein the control data comprises any one of the following items: audio value, exhaling value, shaking frequency, frequency of clicking a resource allocation interface, and eye blink frequency.

4. The resource allocation method according to claim 1, wherein the determining a target interface area corresponding to the control data input by the user comprises:
determining an interface length corresponding to the control data input by the user; and
determining an interface location corresponding to the control data according to a preset reference location and the interface length, and determining an interface area in which the interface location is located as the target interface area.

5. The resource allocation method according to claim 4, wherein:
the control data comprises a plurality of pieces of control data obtained for a plurality of times within a continuous period of time; and
the determining an interface length corresponding to the control data input by the user comprises: determining an interface length corresponding to the each piece of control data obtained for the each time according to a relationship among interface length, control data, and number of obtaining times.

6. The resource allocation method according to claim 4, wherein the determining an interface length corresponding to the control data input by the user comprises:
determining the interface length corresponding to the control data input by the user according to a directly proportional correspondence between the control data and the interface length.

7. The resource allocation method according to claim 1, wherein the determining a target allocation resource according to resource information associated with the target interface area comprises:
determining a target interface area corresponding to control data obtained last time; and
determining resource information associated with the target interface area as the target allocation resource.

8. The resource allocation method according to claim 1, wherein the determining a target allocation resource according to resource information associated with the target interface area comprises:
obtaining a plurality of pieces of resource information associated with each of a plurality of target interface areas respectively; and
determining a largest piece of the plurality of pieces of resource information or a sum value of the plurality of pieces of resource information as the target allocation resource.

9. The resource allocation method according to claim 1, further comprising:
obtaining historical control data of the user; and
comparing the historical control data with the control data, and outputting indication information corresponding to the comparison result.

10. The resource allocation method according to claim 1, further comprising:
obtaining control data of another user; and
comparing the control data of the user with the control data of the another user, and outputting indication information corresponding to the comparison's result.

11. The resource allocation method according to claim 1, wherein the resource allocation interface comprises a controlled object, and the method further comprises:
moving the controlled object to an interface location corresponding to the target interface area.

12. The resource allocation method according to claim 1, wherein the resource allocation interface comprises a controlled object, and the indicating the target interface area comprises:
changing a form of the target interface area to a target form corresponding to the target interface area.

13. The resource allocation method according to claim 1, further comprising:
recording one or more of the target allocation resources allocated within a preset time length to the user; and
if a number of same target allocation resources of the one or more of the target allocation resources reaches a preset value, outputting indication information and stopping the allocation of the same target allocation resources to the user.

14. The resource allocation method according to claim 1, further comprising:
displaying a background picture having an extension effect, wherein a speed of the extension is directly proportional to a change degree of the control data.

15. The resource allocation method according to claim 1, further comprising:
sending an access portal of the resource allocation interface to a sharing platform based on a sharing operation.

16. A resource allocation device, comprising a processor and a non-transitory computer-readable storage medium storing instructions that, when executed by the processor, cause the resource allocation device to perform a method, the method comprising:
obtaining control data input by a user;
determining a target interface area corresponding to the control data input by the user, wherein a displayed resource allocation interface comprises the target interface area; and
determining a target allocation resource according to resource information associated with the target interface area.

17. The resource allocation device according to claim 16, wherein the method further comprises: allocating the target allocation resource to the user, wherein the resource comprises data packets.

18. The resource allocation device according to claim 16, wherein the control data comprises any one of the following items: audio value, exhaling value, shaking frequency, frequency of clicking a resource allocation interface, and eye blink frequency.

19. A resource allocation device, comprising:
a display configured to display a resource allocation interface;
an input device configured to collect control data input by a user; and
a processor configured to: determine a target interface area corresponding to the control data input by the user, wherein the resource allocation interface comprises the target interface area, determine a target allocation resource according to resource information associated with the target interface area, and allocate the target allocation resource to the user.

20. The resource allocation device according to claim 19, wherein:
the resource comprises data packets; and
the control data comprises any one of the following items: audio value, exhaling value, shaking frequency, frequency of clicking a resource allocation interface, and eye blink frequency.
